(19) United States
(12) Patent Application Publication
(10) Pub. No.: US 2007/0214244 A1
(43) Pub. Date: Sep. 13, 2007

(54) System configuration information comparison device and computer program

(75) Inventors: Tomoya Hitokoto, Saitama (JP); Noriyuki Matsui, Shizuoka (JP); Yoko Nakagawa, Saitama (JP); Kazutaka Oki, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD, Tokyo (JP)

(21) Appl. No.: 11/709,122

(22) Filed: Feb. 22, 2007

(30) Foreign Application Priority Data
Mar. 7, 2006 (JP) 2006-061239

(51) Int. Cl. G06F 15/177

(52) U.S. Cl. 709/220

(57) ABSTRACT

A system configuration information comparison device and a computer program are provided that allow easy comparison of system configuration information and a parameter sheet. The invention provides a system configuration information comparison device (130) that includes a receiving portion that receives system configuration information (112) and a parameter sheet (120); a comparison portion that compares the system configuration information (112) and sections of the parameter sheet (120) that correspond with the system configuration information (112); and an output portion that outputs a comparison report (140) for the system configuration information (112) and the parameter sheet (120) based on the result of the comparison of the system configuration information (112) and the sections of the parameter sheet (120) that correspond with the system configuration information (112).

### CROSS REFERENCE TO RELATED APPLICATIONS

The disclosure of Japanese Patent Application No. JP-A-2006-61239 filed on Mar. 7, 2006 including the specification, drawings and abstract is incorporated herein by reference in its entirety.

### BACKGROUND OF THE INVENTION

The present invention relates to a system configuration information comparison device and a computer program.

When configuring a computer system like a server computer or a host computer, the system designer who configures the system designs system configuration information that is setting information that configures the operating system (OS). Then, the system designer installs the OS in accordance with the designed system configuration information.

The system configuration information includes, for example, the computer name, network setting values like the IP address, the subnet mask, and the default gateway, etc, kernel configuration information (configuration) values, and the like, that are necessary for installation of the OS. Then, the system designer installs the OS in accordance with the designed system configuration information.

When the OS is installed, the system designer enters the values for the designed system configuration information in a sheet, and then uses the sheet with the entered values to actually install the OS. Hereinafter, the sheet in which the values for the system configuration information has been entered will be referred to as a “parameter sheet”.

Values for items such as the computer name (host name), the IP address in the network, the kernel configuration information (configuration), and the like, that are necessary for installation of the OS, are entered in the parameter sheet. As a result of entering these values for system configuration information in the parameter sheet, the parameter sheet can be referred to when the computer system is configured, so that the system is configured using correct setting values. In addition, referring to the parameter sheet makes it possible to understand what settings were used to configure the system.

Usually, the system administrator who maintains the computer system visually checks the details of the settings of the computer that has the configured system in order to understand the setting details. The system administrator obtains the system configuration information from the computer, and compares the obtained system configuration information with the parameter sheet entered when the computer system was configured. Accordingly, the system administrator can check whether there are any problems with the settings of the computer system.

Methods of understanding the details of the settings of the computer are known such as a method in which information for the setting file of the computer is recorded in a database, and then file modification and update information are output. For an example, refer to Japanese Patent Application Publication No. JP-A-2001-84132.

However, there may be several hundreds of files in the system configuration information. As a result, methods in which the system configuration information and the parameter sheet are visually compared are problematic because the number of items that have to be compared is large, and thus comparison takes a long time. In addition, if the comparison is performed visually, when there is a request to check the kernel parameters, for example, it is quite likely that checking of an item will be overlooked, or a checking mistake will be made due to, for example, the system administrator overlooking a problem in the network, or failing to delete a crash dump.

### SUMMARY OF THE INVENTION

The present invention has been devised in light of the above-described problems, and it is an object thereof to provide a new and innovative system configuration information comparison device and a computer program that can easily compare system configuration information and a parameter sheet.

In order to address the above-described problem, a first aspect of the present invention provides a system configuration information comparison device for comparing system configuration information, which is information about an operating system that controls a computer system, and a parameter sheet in which system configuration information used when configuring the computer system is entered. The system configuration information comparison device includes: a receiving portion that receives the system configuration information and the parameter sheet; a comparison portion that compares the system configuration information and sections of the parameter sheet that correspond with the system configuration information; and an output portion that outputs a comparison report for the system configuration information and the parameter sheet based on the result of the comparison of the system configuration information and the sections of the parameter sheet that correspond with the system configuration information.

According to the above-described configuration, the receiving portion receives the system configuration information and the parameter sheet, and then the comparison portion compares the system configuration information and the sections of the parameter sheet that correspond with the system configuration information. Then, the output portion outputs the comparison report for the system configuration information and the parameter sheet. As a result, the system configuration information comparison device according to this aspect of the present invention can output a comparison report that is generated from the expansive system configuration information obtained from the computer system, and the parameter sheet created when the computer system was configured. Accordingly, the points of difference of the system configuration information and the parameter sheet can be easily understood. In addition, an engineer who is not specifically trained in reading system configuration information can easily understand the details of the system configuration information by reading the comparison report.

The system configuration information comparison device may include a web page display portion that displays a web page that is accessible from outside using a web browser. Further, the system configuration information comparison device may be configured such that the system configuration information and the parameter sheet are transmittable from the web browser via the web page displayed by the display portion. According to this configuration, the web page display portion displays a web page via which the system configuration information and the parameter sheet can be transmitted from the web browser. As a result, so long as an environment is provided that allows the web page displayed by the web page display portion to be accessed, it is possible for the system configuration information and the parameter sheet to be transmitted from the environment.

The output portion may output the comparison report in a format that can be displayed by the web browser. As a result, the comparison report can be viewed from a terminal that can use the web browser.

In order to solve the above-described problems, a second aspect of the invention provides a system configuration information comparison device for comparing at least two sets of system configuration information, which is information about an operating system that controls a computer system. The system configuration information comparison device includes: a receiving portion that receives first system configuration information and second system configuration information, which are pieces of information about the operating system that controls the computer system; a comparison portion that compares the first system configuration information and the second system configuration information; and an output portion that outputs a comparison report for the first system configuration information and the second system configuration information based on the result of the comparison of the first system configuration information and the second system configuration information.

According to this structure, the receiving portion receives the first system configuration information and the second system configuration information, and then the comparison portion compares the first system configuration information and the second system configuration information. Then, the output portion outputs the comparison report for the first system configuration information and the second system configuration information. As a result, the system configuration information comparison device according to the second aspect of the present invention can output a comparison report that is generated from the two sets of expansive system configuration information obtained from the computer system. Accordingly, the points of difference of the two sets of system configuration information can be easily understood. In addition, an engineer who is not specifically trained in reading system configuration information can easily understand the details of the system configuration information by reading the comparison report.

The first system configuration information and the second system configuration information may be respective sets of information about different computers. If this configuration is adopted, it is easy to understand the points of difference of the system configuration information of the two computers.

The above system configuration information comparison device may also include a web page display portion that displays a web page that is accessible from outside of the device using a web browser. Furthermore, the system configuration information comparison device may be configured such that the first system configuration information and the second system configuration information can be transmitted from the web browser via the web page displayed by the display portion. According to this configuration, the web page display portion displays a web page via which the first system configuration information and the second system configuration information can be transmitted from the web browser. As a result, so long as an environment is provided that allows the web page displayed by the web page display portion to be accessed, it is possible for the first system configuration information and the second system configuration information to be transmitted from the environment.

The output portion may output the comparison report in a format that can be displayed by the web browser. As a result, the comparison report can be viewed from a terminal that can use the web browser.

In order to solve the above-described problems, a third aspect of the present invention provides a computer program that comprises instructions that command a computer system to execute the steps of: receiving system configuration information and a parameter sheet, the system configuration information being information about an operating system that controls a computer system, and the parameter sheet including entered system configuration information that was used when configuring the computer system; comparing the system configuration information and sections of the parameter sheet that correspond with the system configuration information; and outputting a comparison report for the system configuration information and the parameter sheet, the comparison report being based on the result of the comparison of the system configuration information and the sections of the parameter sheet that correspond with the system configuration information.

According to the above-described configuration, the system configuration information and the parameter sheet are received, and then the received system configuration information and the sections of the parameter sheet that correspond with the system configuration information are compared. Then, the comparison report is output based on the comparison of the system configuration information and the parameter sheet. As a result, the computer program according to the third aspect of the present invention can output a comparison report that is generated from the expansive system configuration information obtained from the computer system, and the parameter sheet created when the computer system was configured. Accordingly, the points of difference of the system configuration information and the parameter sheet can be easily understood. In addition, an engineer who is not specifically trained in reading system configuration information can easily understand the details of the system configuration information by reading the comparison report.

The comparison report may be output in a format that can be displayed by a web browser. As a result, the comparison report can be viewed from a terminal that can use the web browser.

In order to solve the above-described problems, a fourth aspect of the present invention provides a computer program that comprises instructions that command a computer system to execute the steps of: receiving first system configuration information and second system configuration information, the first system configuration information and the second system configuration information being information about an operating system that controls a computer system; comparing the first system configuration information and the second system configuration information; and outputting a comparison report for the first system configuration information and the second system configuration information based on the result of the comparison of the first system configuration information and the second system configuration information.

According to the above-described configuration, the first system configuration information and the second system configuration information are received, and then the received first system configuration information and the second system configuration information are compared. Then, the comparison report is output based on the comparison of the first system configuration information and the second system configuration information. As a result, the computer program according to the fourth aspect of the present invention can output a comparison report that is generated from the two sets of expansive system configuration information obtained from the computer system. Accordingly, the points of difference of the first and second system configuration information can be easily understood. In addition, an engineer who is not specifically trained in reading system configuration information can easily understand the details of the system configuration information by reading the comparison report.

The comparison report may be output in a format that can be displayed by a web browser. As a result, the comparison report can be viewed from a terminal that can use the web browser.

The present invention provides a system configuration information comparison device and a computer program.

### BRIEF DESCRIPTION OF THE DRAWINGS

FIG. 1 is an explanatory diagram that illustrates an outline of a first embodiment of the present invention;

FIG. 2 is an explanatory diagram that illustrates a system configuration information comparison device of the first embodiment of the present invention;

FIG. 3 is a flow chart that illustrates a system configuration information comparison method of the first embodiment of the present invention;

FIG. 4 is an explanatory diagram that shows an example of system configuration information of the first embodiment of the present invention;

FIG. 5 is an explanatory diagram that shows an example of a parameter sheet of the first embodiment of the present invention;

FIG. 6 is an explanatory diagram showing an example of a comparison report of the first embodiment of the present invention;

FIG. 7 is an explanatory diagram that illustrates an outline of a second embodiment of the present invention; and

FIG. 8 is a flow chart that illustrates a system configuration information comparison method of the second embodiment of the present invention.

### DETAILED DESCRIPTION OF THE PREFERRED EMBODIMENTS

Hereinafter, preferred embodiments of the present invention will be described in detail with reference to the appended drawings. Note that, in this specification and the drawings, structural elements that have substantially the same function and structure are denoted with the same reference numerals, and repeated explanation of these structural elements is omitted.

### First Embodiment

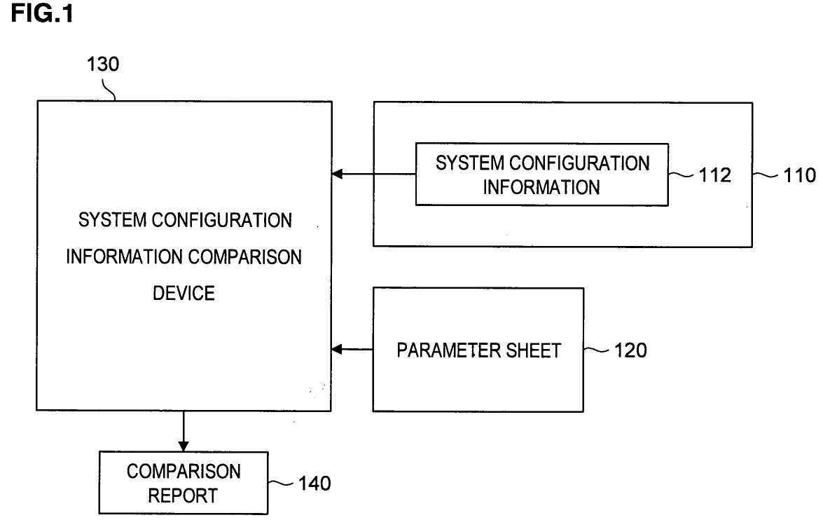

The first embodiment describes an example of a system configuration information comparison device that compares system configuration information of a computer system and information entered in a parameter sheet used when configuring the computer system, and then outputs information. First, an outline of the first embodiment of the invention will be explained while referring to FIG. 1.

FIG. 1 is an explanatory diagram that illustrates an outline of the first embodiment of the present invention. System configuration information 112 that is set in a computer system 110 is sent to a system configuration information comparison device 130. When the system configuration information 112 is sent to the system configuration information comparison device 130, a parameter sheet 120 that was used when the computer system 110 was configured is also sent to the system configuration information comparison device 130.

The system configuration information 112 is sent to the system configuration information comparison device 130 in the form of a text file. The parameter sheet 120 may be sent to the system configuration information comparison device 130 at the same time as, before or after the system configuration information 112 is sent.

The system configuration information 112 may be sent from the computer system 110 to the system configuration information comparison device 130 using File Transfer Protocol (FTP), or sent using HyperText Transfer Protocol (HTTP). Similarly, the parameter sheet 120 may be sent to the system configuration information comparison device 130 using FTP or sent using HTTP.

Once the system configuration information comparison device 130 has received the system configuration information 112 and the parameter sheet 120, the system configuration information comparison device 130 identifies and extracts points of agreement and points of difference between the system configuration information 112 and the parameter sheet 120, and then outputs a comparison report 140 based on the information concerning the extracted points of agreement and points of difference.

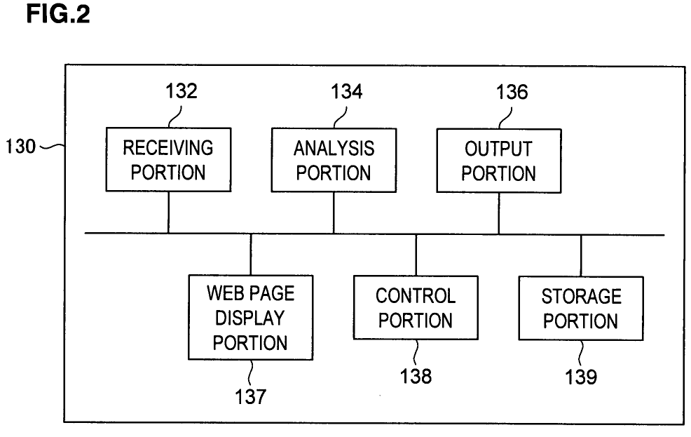

This completes the explanation of the outline of the first embodiment of the present invention. Next, FIG. 2 will be used to explain the structure of the system configuration information comparison device 130 of the first embodiment of the present invention.

FIG. 2 is an explanatory diagram that illustrates the system configuration information comparison device 130 according to the first embodiment of the present invention. Referring to FIG. 2, the system configuration information comparison device 130 according to the first embodiment of the present invention includes a receiving portion 132, an analysis portion 134, an output portion 136, a web page display portion 137, a control portion 138, and a storage portion 139.

The receiving portion 132 receives the system configuration information 112 and the parameter sheet 120 of the computer system 110. The receiving portion 132 sends the received system configuration information 112 and the parameter sheet 120 to the analysis portion 134.

The analysis portion 134 analyses the system configuration information 112 and the parameter sheet 120 received by the receiving portion 132, and detects the points of agreement and points of difference between them. Then, the analysis portion 134 sends information concerning the points of agreement and points of difference of the system configuration information 112 and the parameter sheet 120 to the output portion 136.

The output portion 136 generates a comparison report from the information concerning the points of agreement and points of difference of the system configuration information 112 and the parameter sheet 120 detected by the analysis portion 134, and outputs the comparison report. In the present embodiment, the comparison report is displayed in HyperText Markup Language (HTML) format. As a result of outputting the comparison report using HTML format, it is possible to check the points of agreement and points of difference of the system configuration information 112 and the parameter sheet 120 using an information processing device that has an installed web browser.

The web page display portion 137 displays a web page that can be accessed from outside using a web browser. The displayed web page is created such that files can be sent. The system configuration information and the parameter sheet may be sent to the system configuration information comparison device 130 via the web page displayed by the web page display portion 137.

The control portion 138 controls the operations of the various portions of the system configuration information comparison device 130. The control portion 138 includes, for example, a CPU, a RAM, and a ROM.

The storage portion 139 stores various types of information related to the system configuration information comparison device 130. And the storage portion 139 is configured by, for example, a hard disk drive. The storage portion 139 may also store computer programs that are used to perform processing that controls the receiving portion 132, the analysis portion 134, the output portion 136, and the web page display portion 137 in accordance with commands received from the control portion 138.

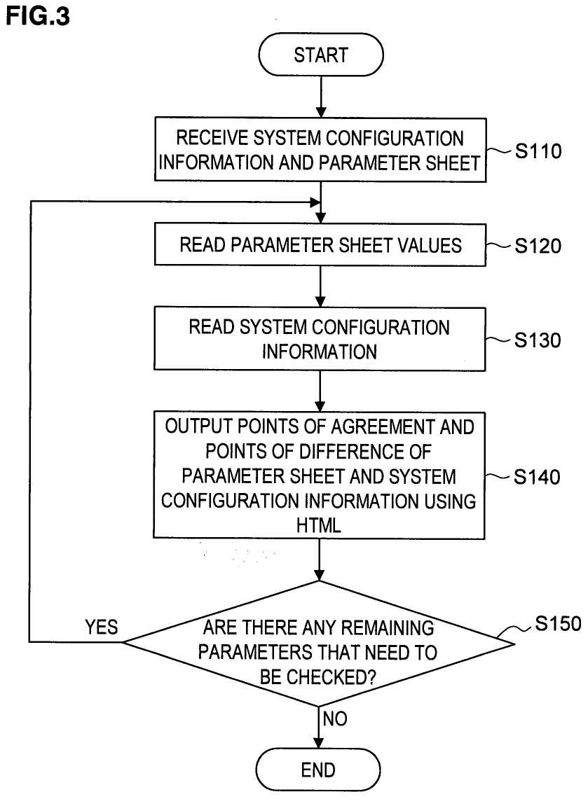

This completes the explanation of the system configuration information comparison device 130 according to the first embodiment of the present embodiment using FIG. 2. Next, FIG. 3 will be used to explain the system configuration information comparison method according to the first embodiment of the present invention.

FIG. 3 is a flow chart that illustrates the system configuration information comparison method of the first embodiment of the present invention. First, the receiving portion 132 of the system configuration information comparison device 130 receives the system configuration information 112 and the parameter sheet 120 of the computer system 110 (step S110).

When the receiving portion 132 has completed receiving of the system configuration information 112 and the parameter sheet 120, the analysis portion 134 reads the values entered in the parameter sheet 120 (step S120), and then also reads the values of the system configuration information 112 (step S130). In the present embodiment, the values of the parameter sheet 120 and the system configuration information 112 are read in that order. However, the order of reading may be changed so that the system configuration information 112 is read before the parameter sheet 120.

When reading of the values of the system configuration information 112 and the parameter sheet 120 is completed, the points of agreement and points of difference of the items (parameters) that are the same in both are detected, and then the points of agreement and points of difference are output using HTML in a way that makes the points of agreement and points of difference clearly apparent (step S140). For example, in order to output the points of agreement and points of difference in a way that makes them clearly apparent, the points of agreement may be displayed in blue and the points of difference may be displayed in yellow. As will be readily apparent the color combination is not limited to that described here.

Next, a confirmation check is performed to see if there are any remaining parameters that need to be checked (step S150). If there are remaining parameters, the process returns to step S120 where the system configuration information 112 and the parameter sheet 120 are read. If there are no remaining parameters, the process is ended.

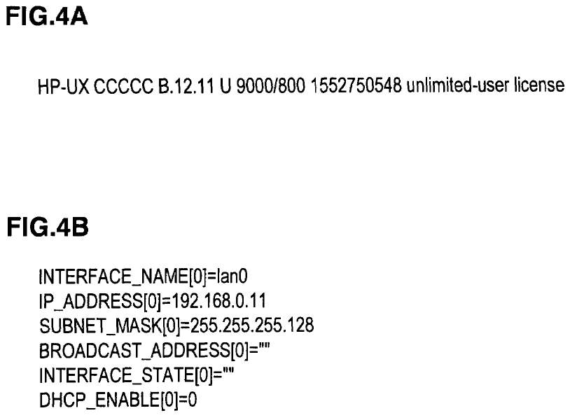

This completes the explanation of the system configuration information comparison method according to the first embodiment of the present invention using FIG. 3. Next, FIGS. 4 to 6 will be used to explain the system configuration information comparison results of the first embodiment.

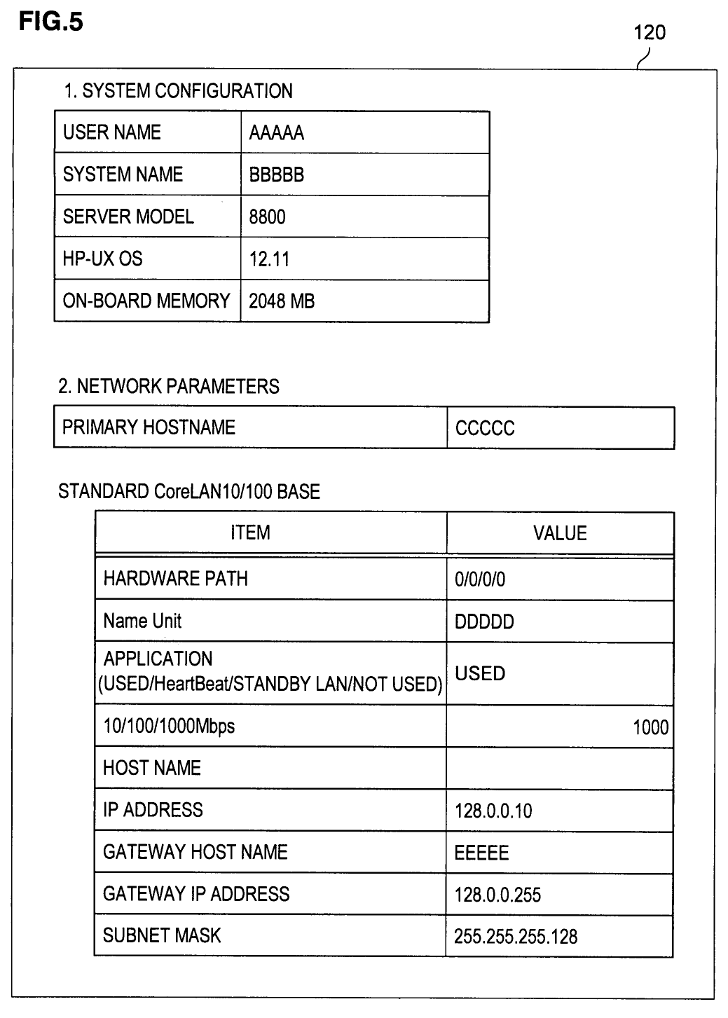

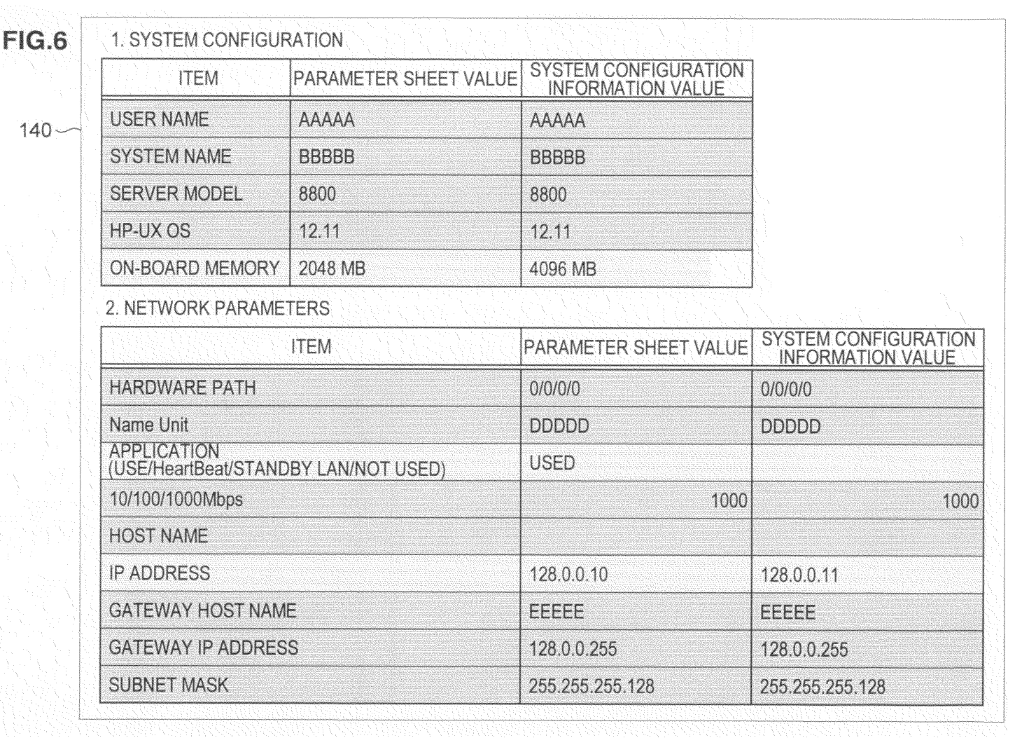

FIG. 4A and FIG. 4B are explanatory diagrams that show an example of system configuration information according to the first embodiment of the present invention. FIG. 5 is an explanatory diagram that shows an example of a parameter sheet of the first embodiment of the present invention. FIG. 6 is an explanatory diagram showing an example of a comparison report of the first embodiment of the present invention.

FIG. 4A shows information related to a host name, the OS version number, and the like. FIG. 4B shows network-related information in the system configuration information.

In FIG. 4A, the host name, “CCCCC”, is entered in the 2^{nd} column, and the OS version number, “12.11”, is entered in the 3^{rd} column.

In addition, in FIG. 4B, “192.168.0.11” is entered in the “IP_ADDRESS [0]” field, and indicates that the IP address of the computer that has the system configuration information is “192.168.0.11”. Furthermore, “255.255.255.128” is entered in the “SUBNET_MASK [0]” field, and indicates that the subnet mask of the computer that has the system configuration information is “255.255.255.128”.

As will be readily apparent, FIG. 4A and FIG. 4B only show one part of the system configuration information 112. In addition to network setting information, values for the file system setting information, the setting information for the kernel parameters, and the like, are also set.

In addition, in the parameter sheet 120 shown in FIG. 5, in “1. System Configuration”, “AAAAA” is set for the “User Name”, “BBBBB” is set for the “System Name”, “8800” is set for the “Server Model”, “12.11” is set for “HP-UX OS”, and “2048 MB” is set for the “On-Board Memory”. Further, in “2. Network Parameters”, “CCCCC” is set for the “Primary Hostname”, and in “Standard CoreLAN 10/100 Base”, “0/0/0/0” is set for the “Hardware Path”, “DDDDD” is set for the “Name Unit”, “Used” is set for “Application (Use/HeartBeat/Standby LAN/Not Used”, “1000” is set for “10/100/1000 Mbps”, the “Host Name” is left blank, “128.0.0.10” is set for the “IP Address”, “EEEEE” is set for the “Gateway Host Name”, “128.0.0.255” is set for the “Gateway IP Address”, and “255.255.255.128” is set for the “Subnet Mask”.

As will be readily apparent, FIG. 5 just shows one section of the parameter sheet 120. In addition to the network setting information, it is possible to provide columns for entering values for the file system setting information, the setting information for the kernel parameters, and the like, and values for the respective types of setting information may be entered or selected.

FIG. 6 shows an example of the comparison report 140 that indicates the results of a comparison of the system configuration information 112 shown in FIG. 4, and the parameter sheet shown in FIG. 5. With regard to some of the items in the “1.System Configuration” field, namely, the “User Name”, the “System Name”, the “Server Model”, and “HP-UX OS”, the values of the parameter sheet and the system configuration information 112 are the same. However, the values of the parameter sheet and the system configuration information 112 for the “On-Board Memory” item are different. Items in the parameter sheet and the system configuration information that have the same values are displayed in blue (in FIG. 6, for the sake of convenience these items are displayed using dark shading), and items in the parameter sheet and the system configuration information that have different values are displayed using yellow (in FIG. 6, for the sake of convenience these items are displayed using light shading).

As will be readily apparent, FIG. 6 shows just one section of the comparison report 140. In addition to the network setting information, values for the file system setting information, setting information for kernel parameters, and the like, may be compared, and the results of the comparison may be displayed in the comparison report 140.

The first embodiment of the present invention described above provides a system configuration information comparison device that can display the points of agreement and points of difference of the system configuration information of the computer system and the parameter sheet used when configuring the computer system in an easily understandable manner. In addition, the described system configuration information comparison device allows comparison to be carried out accurately and quickly as compared to known methods in which files are checked visually.

### Second Embodiment

In the first embodiment of the present invention, the described system configuration information comparison device can display the points of agreement and points of difference of the system configuration information of the computer system and the parameter sheet used when configuring the computer system in an easily understandable manner and can carry out comparison accurately and quickly as compared to the know method in which files are visually compared.

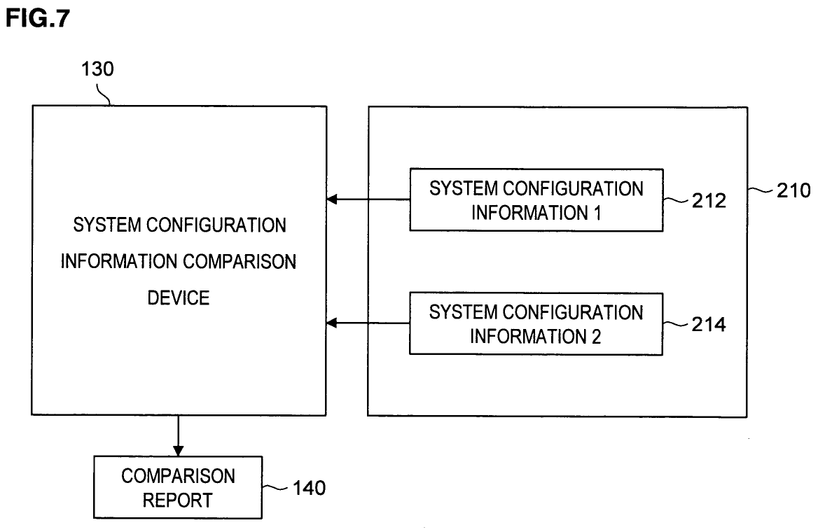

A second embodiment will describe an example of a system configuration information comparison device that compares the system configuration information of two computers that is configured using a cluster configuration. First, FIG. 7 will be used to explain an outline of the second embodiment of the present invention.

FIG. 7 is an explanatory diagram that illustrates an outline of the second embodiment of the present invention. In this embodiment, the system configuration information comparison device 130 receives pre-modification system configuration information 212 that is first system configuration information, and post-modification system configuration information 214 that is second system configuration information from a computer system 210. The pre-modification system configuration information 212 and the post-modification system configuration information 214 are sent in text file format, and are system configuration information for different computers.

Once the system configuration information comparison device 130 has received the pre-modification system configuration information 212 and the post-modification system configuration information 214, the system configuration information comparison device 130 compares the pre-modification system configuration information 212 and the post-modification system configuration information 214, identifies and extracts points of agreement and points of difference between them, and then outputs a comparison report 140.

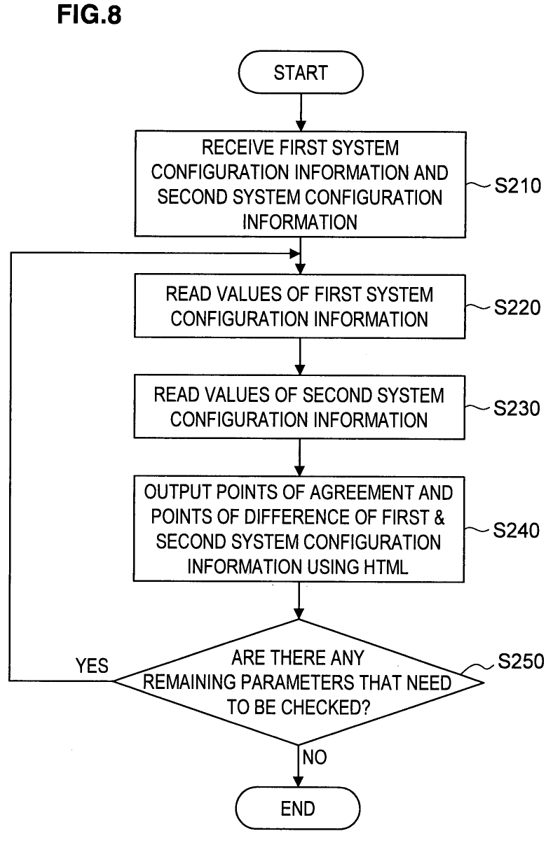

This completes the explanation of the outline of the second embodiment of the present invention using FIG. 7. The structure of the system configuration information comparison device 130 according to the second embodiment of the present invention is the same as that of the first embodiment, and thus a detailed explanation will be omitted here. Next, FIG. 8 will be used to explain the system configuration information comparison method according to the second embodiment of the present invention.

FIG. 8 is a flow chart that illustrates the system configuration information comparison method of the second embodiment of the present invention. First, the receiving portion 132 of the system configuration information comparison device 130 receives the pre-modification system configuration information 212 and the post-modification system configuration information 214 of the computer system 210 (step S210).

When the receiving portion 132 has completed receiving of the pre-modification system configuration information 212 and the post-modification system configuration information 214, the analysis portion 134 reads the values entered in the pre-modification system configuration information 212 (step S220), and then also reads the values of the post-modification system configuration information 214 (step S230).

When reading of the values of the pre-modification system configuration information 212 and the post-modification system configuration information 214 is completed, the points of agreement and points of difference of the items (parameters) that are the same in both are detected, and then the points of agreement and points of difference are output using HTML in a way that makes the points of agreement and points of difference clearly apparent (step S240). For example, in order to output the points of agreement and points of difference in a way that makes them clearly apparent using HTML, the points of agreement may be displayed in blue and the points of difference may be displayed in yellow. As will readily apparent the color combination is not limited to that described here.

Next, a confirmation check is performed to see if there are any remaining parameters that need to be checked (step S250). If there are remaining parameters, the process returns to step S220 where the pre-modification system configuration information 212 and the post-modification system configuration information 214 are read. If there are no remaining parameters, the process is ended.

The second embodiment of the present invention described above can compare the settings of two computers that are configured using a cluster configuration, and easily identify any difference between the settings of the two computers.

Hereinabove, preferred embodiments of the present invention have been described with reference to the appended drawings. However, as will be readily apparent, the present invention is not limited to these embodiments. As will be obvious to a person skilled in the art, the invention permits of various modifications and changes without departing from the scope of the claims. Such modifications and changes are understood to come within the scope of the present invention.

For example, in the second embodiment, the settings of the two computers configured using a cluster configuration are compared. However, when the computer system is configured, the system configuration information may be acquired in advance. If a fault/failure occurs in the configured computer system, the system configuration information at the time when the fault/failure occurs may be acquired. The system configuration information used when the computer system was configured and the system configuration information at the time when the fault/failure occurs may then be sent to the system configuration information comparison device for comparison. The system configuration information comparison device can then receive the two sets of system configuration information, and outputs a comparison report, thereby allowing the cause of the fault/failure to be identified, for example, whether the fault/failure was caused by modification of the computer settings.

In addition, in the case that a fault/failure of the configured computer system occurs, there are occasions when a replication environment is separately configured in order to analyze the fault/failure. Accordingly, the system configuration information at the time when the fault/failure occurred, and the system configuration information of the replication environment may be obtained and sent to the system configuration information comparison device for comparison. The system configuration information comparison device can then receives the two sets of system configuration information, compare them, and output a comparison report. Outputting of the comparison report by the system configuration information comparison device that receives the two sets of system configuration information makes it possible to check whether the replication environment is configured correctly.

The present invention may be applied to a system configuration information comparison device or to a computer program.

What is claimed is:

1. A system configuration information comparison device for comparing system configuration information, which is information about an operating system that controls a computer system, and a parameter sheet in which system configuration information used when configuring the computer system is entered, the system configuration information comparison device comprising:
a receiving portion that receives the system configuration information and the parameter sheet;
a comparison portion that compares the system configuration information and sections of the parameter sheet that correspond with the system configuration information; and
an output portion that outputs a comparison report for the system configuration information and the parameter sheet based on the result of the comparison of the system configuration information and the sections of the parameter sheet that correspond with the system configuration information.

2. The system configuration information comparison device according to claim 1, further comprising:
a web page display portion that displays a web page that is accessible from outside using a web browser, wherein
the system configuration information and the parameter sheet are transmittable from the web browser via the web page displayed by the display portion.

3. The system configuration information comparison device according to claim 1, wherein
the output portion outputs the comparison report in a format that can be displayed by the web browser.

4. A system configuration information comparison device for comparing at least two sets of system configuration information, which is information about an operating system that controls a computer system, the system configuration information comparison device comprising:
a receiving portion that receives first system configuration information and second system configuration information, which is information about the operating system that controls the computer system;
a comparison portion that compares the first system configuration information and the second system configuration information; and
an output portion that outputs a comparison report for the first system configuration information and the second system configuration information based on the result of the comparison of the first system configuration information and the second system configuration information.

5. The system configuration information comparison device according to claim 4, wherein
the first system configuration information and the second system configuration information are respective sets of information about different computers.

6. The system configuration information comparison device according to claim 4, further comprising:
a web page display portion that displays a web page that is accessible from outside using a web browser, wherein
the first system configuration information and the second system configuration information are transmittable from the web browser via the web page displayed by the display portion.

7. The system configuration information comparison device according to claim 4, wherein
the output portion outputs the comparison report in a format that can be displayed by the web browser.

8. A computer program that comprises instructions that command a computer system to execute the steps of:
receiving system configuration information and a parameter sheet, the system configuration information being information about an operating system that controls a computer system, and the parameter sheet including entered system configuration information that was used when configuring the computer system;
comparing the system configuration information and sections of the parameter sheet that correspond with the system configuration information; and
outputting a comparison report for the system configuration information and the parameter sheet, the comparison report being based on the result of the comparison of the system configuration information and the sections of the parameter sheet that correspond with the system configuration information.

9. The computer program according to claim 8, wherein
the comparison report is output in a format that can be displayed on a web browser.

10. A computer program that comprises instructions that command a computer system to execute the steps of:
receiving first system configuration information and second system configuration information, the first system configuration information and the second system configuration information being information about an operating system that controls a computer system;
comparing the first system configuration information and the second system configuration information; and
outputting a comparison report for the first system configuration information and the second system configuration information based on the result of the comparison of the first system configuration information and the second system configuration information.

11. The computer program according to claim 10, wherein
the comparison report is output in a format that can be displayed on a web browser.
